(19) United States
(12) Patent Application Publication
(10) Pub. No.: US 2008/0222214 A1
(43) Pub. Date: Sep. 11, 2008

(54) STORAGE SYSTEM AND REMOTE COPY SYSTEM RESTORING DATA USING JOURNAL

(76) Inventors: Seisuke Tokuda, Kokubunji (JP); Shinji Fujiwara, Sagamihara (JP)

Correspondence Address: MATTINGLY, STANGER, MALUR & BRUNDIDGE, P.C., 1800 DIAGONAL ROAD, SUITE 370, ALEXANDRIA, VA, 22314, US

(21) Appl. No.: 11/758,696

(22) Filed: Jun. 6, 2007

(30) Foreign Application Priority Data
Mar. 9, 2007 (JP) 2007-59764

(51) Int. Cl. G06F 17/30

(52) U.S. Cl. 707/202; 707/E17.017; 707/E17.032

(57) ABSTRACT

This invention provides a storage system including: a control unit; a first storage device for storing data; and a second storage device for storing journals of the data stored in the first storage device, in which: the first storage device has a RAID configuration for recording parity data dispersedly in a plurality of physical storage devices; and the control unit is configured to: create updated parity data based on updated data included in an update instruction; store the updated data and the updated parity data in the first storage device; record a journal including the updated data and the updated parity data in the second storage device; and read sequentially at least one of the journals upon reception of an instruction to restore the data stored in the first storage device to write the updated data and the updated parity data contained in the read journals in the first storage device.

### CLAIM OF PRIORITY

The present application claims priority from Japanese patent application JP 2007-059764 filed on Mar. 9, 2007, the content of which is hereby incorporated by reference into this application.

### BACKGROUND OF THE INVENTION

This invention relates to a technique of restoring data stored in a storage system.

In on-line processing and batch processing carried out in an information processing system, a program bug or a failure of the information processing system may cause an abnormal end of the processing, making inconsistent data stored in the storage system. A human error may cause deletion of the data stored in the storage system.

One of the techniques for restoring the data in such a status, which is stored in the storage system, is a journaling technique of constantly recording update history (will be referred to as “journal” hereinafter) of the data.

One of conventional techniques regarding the journaling technique is disclosed in JP 2004-252686 A. In the technique disclosed in JP 2004-252686 A, every time an instruction to update data stored in a storage device of a storage system is received, the storage system creates a journal and records the journal in another storage device. The recorded journal is used to recover (will be referred to as “restore” hereinafter) data held at a most recent or past time instant.

In the storage system based on the journal technique disclosed in JP 2004-252686 A, when a journal containing updated data is restored in a logical storage device having a redundant array of independent disks (RAID) configuration, for example, a logical storage device having a RAID 5 configuration, for dispersing and recording parity data which is redundant data in a plurality of physical storage devices, write penalties (reading of data before updating, and reading of parity data before updating) unique to the RAID 5 for regenerating parity data are inevitable, thereby extending restoration time.

This invention provides a storage system which can achieve a high speed for a journal restoration process in a logical storage device constructed of RAID by storing updated parity data together with updated data as a journal in normal journal creation, and reading the journal to restore data included in the journal without generating any write penalties in journal restoration.

### SUMMARY OF THE INVENTION

A representative aspect of this invention is as follows. That is, there is provided a storage system coupled to a host computer, comprising: a control unit for processing an access request transmitted from the host computer; a first storage device for storing data accessed by the host computer; and a second storage device for storing update content of the data stored in the first storage device as a journal, in which the first storage device has a RAID configuration for recording parity data dispersedly in a plurality of physical storage devices; and the control unit is configured to: create updated parity data based on updated data in case of reception of an instruction of updating the data stored in the first storage device, store the updated data and the updated parity data in the first storage device, create at least one journal including the updated data and the updated parity data, and record the created journal in the second storage device; read sequentially at least one of the journals recorded in the second storage device in the recorded order in case of reception of a data restore instruction including the restore point for the data stored in the first storage device, and write the updated data and the updated parity data included in the read journal in the first storage device.

According to an embodiment of this invention, the data can be restored at a high speed without regenerating updated parity data by generating the updated parity data together with the updated data as the journal, and reading the journal containing the updated parity data during data restoration.

### BRIEF DESCRIPTION OF THE DRAWINGS

The present invention can be appreciated by the description which follows in conjunction with the following figures, wherein:

FIG. 1 is a block diagram showing a hardware configuration of a computer system including a storage system in accordance with a first embodiment of this invention;

FIG. 2 is a block diagram showing a program configuration and a logical configuration of the storage system in accordance with the first embodiment of this invention;

FIG. 3 is an explanatory diagram showing a RAID configuration of a journal acquisition storage device in accordance with the first embodiment of this invention;

FIG. 4 is an explanatory diagram showing a mapping management table included in a device management information in accordance with the first embodiment of this invention;

FIG. 5 is an explanatory diagram showing a parity group management table included in the device management information in accordance with the first embodiment of this invention.

FIG. 6 is an explanatory diagram showing a logical storage device management table included in the device management information in accordance with the first embodiment of this invention;

FIG. 7 is an explanatory diagram showing an example of journal management information included in a journal control program in accordance with the first embodiment of this invention;

FIG. 8 is an explanatory diagram showing an example of snapshot management information included in a snapshot control program in accordance with the first embodiment of this invention;

FIG. 9 is a flowchart showing a procedure of a journal acquisition start process in accordance with the first embodiment of this invention;

FIG. 10 is a flowchart showing a procedure of a snapshot creation process in accordance with the first embodiment of this invention;

FIG. 11 is a flowchart showing a read/write I/O processing procedure in accordance with the first embodiment of this invention;

FIG. 12 is a flowchart showing a procedure of a journal creation process in accordance with the first embodiment of this invention;

FIG. 13 is a diagram showing a journal data form in accordance with the first embodiment of this invention;

FIG. 14 is a flowchart showing a procedure of a restore process in accordance with the first embodiment of this invention;

FIG. 15 is an explanatory diagram showing an example of a setting screen of a journal configuration option in accordance with the first embodiment of this invention;

FIG. 16 is a block diagram showing a hardware configuration and a logical configuration of a remote copy system in accordance with the second embodiment of this invention;

FIG. 17 is a flowchart showing a procedure of a remote copy start preparation process in accordance with the second embodiment of this invention;

FIG. 18 is a flowchart showing a procedure of a remote copy process in accordance with the second embodiment of this invention; and

FIG. 19 showing an example of a setting screen of a remote copy journal configuration option in accordance with the second embodiment of this invention.

### DETAILED DESCRIPTION OF THE PREFERRED EMBODIMENTS

The preferred embodiments this invention will be described below referring to the drawings.

### First Embodiment

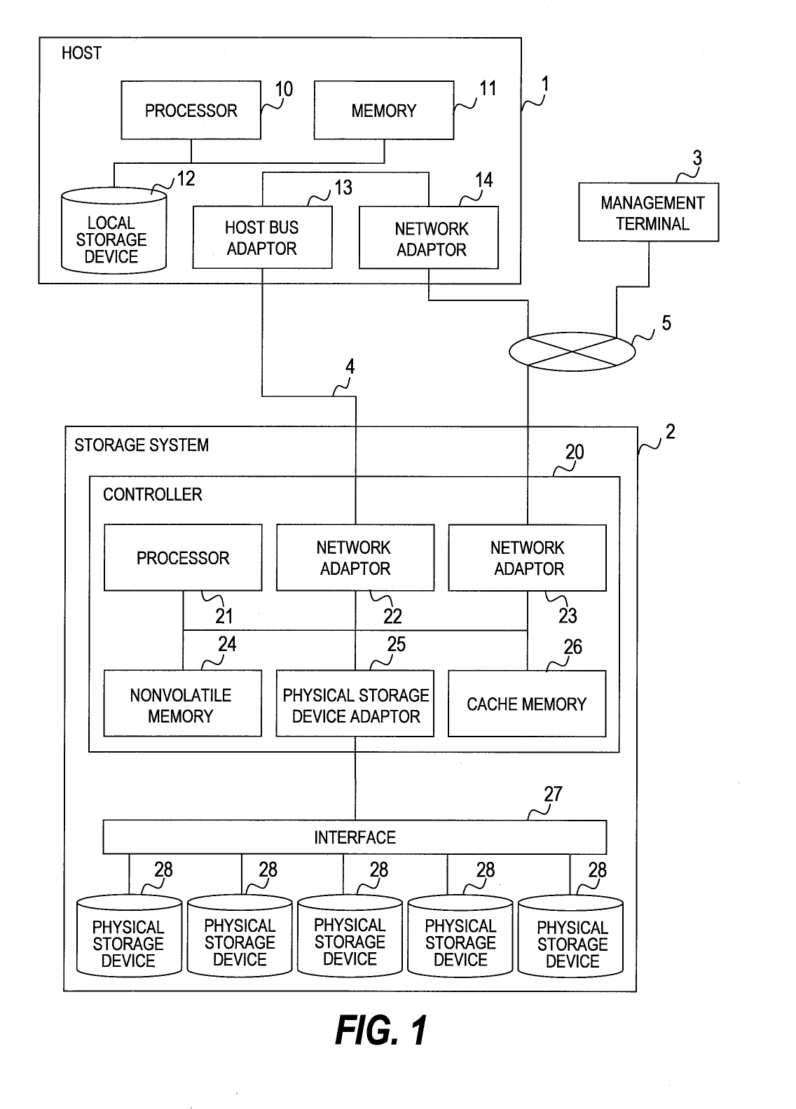

FIG. 1 is a block diagram showing a hardware configuration of a computer system including a storage system in accordance with a first embodiment of this invention. The computer system shown in FIG. 1 comprises a host computer 1, a storage system 2, a management terminal 3, a network 4 and another network 5.

The host computer 1 is a computer such as a personal computer, a workstation, and a mainframe. In the host computer 1, an operating system (will be referred to as “OS” hereinafter) selected according to use for the host computer 1, and application program (will be referred to as “AP” hereinafter) providing various service and application (e.g. a database management system (will be referred to as “DBMS” hereinafter)) are operated.

The host computer 1 comprises a processor 10, a memory 11, a local storage device 12, a host bus adaptor 13 and a network adaptor 14.

The processor 10 executes a predetermined program. The memory 11 temporarily stores thereinto the OS and the AP executed by the processor 10, and data used by the AP.

The local storage device 12 stores thereinto the OS, the AP, and data used by the AP. The host bus adaptor 13 couples the network 4 to the host computer 1. The network adaptor 14 couples the network 5 to the host computer 1.

According to the first embodiment of this invention, one host computer 1 is described for simplicity. However, there is no limitation on the number of host computers 1 connected to the networks 4 and 5. The host computer 1 may include a plurality of processors 10 or the like to secure redundancy.

The storage system 2 comprises a storage device such as a disk drive, or a plurality of storage devices such as disk arrays. The storage system 2 stores thereinto data and programs which are used by the host computer 1. The storage system 2 receives an input and output process request (will be referred to as “I/O request” hereinafter) sent from the host computer 1, executes a process operation in accordance with the received I/O request, and transmits a processed result to the host computer 1.

The storage system 2 comprises a control unit 20, a interface 27 and a physical storage device 28. The interface 27 couples the physical storage device 28 to the control unit 20 with each other.

The control unit 20 executes a process operation in accordance with I/O request issued from the host computer 1, and a control operation of the physical storage device 28. The control unit 20 comprises a processor 21, a non-volatile memory 24, a cache memory 26, a physical storage device adaptor 25, a network adaptor 22, and another network adaptor 23.

The processor 21 executes a predetermined program. The non-volatile memory 24 stores thereinto a program executed by the processor 21, information which is required to execute the program, and setting information, configuration information of the storage system 2. The cache memory 26 temporarily stores thereinto data inputted from the host computer 1, and data transferred from the storage system 2 to the host computer 1.

The physical storage device adaptor 25 is coupled to the physical storage device 28 via the interface 27. The network adaptor 22 couples the storage system 2 to the network 4. The network adaptor 23 couples the storage system 2 to the network 5.

The physical storage device 28 stores thereinto data which is used by the host computer 1. The physical storage device 28 is a non-volatile storage medium, for instance, a hard disk constructed of magnetic disks, and the like.

The storage system 2 may include a plurality of controllers 20. In the storage system 2, to secure redundancy, the components including the nonvolatile memory 24, the cache memory 26, the physical storage device adaptor 25, and the interface 27 may have a redundant structure.

The management terminal 3 is used in order to perform maintenance and management operations of the storage system 2, and to set configuration of the host computer 1. In the case where an administrator of the computer system performs maintenance and/or management operation of the storage system 2 (e.g. creating logical storage device in the storage system 2), the administrator inputs setting to the management terminal 3. The management terminal 3 transmits the setting inputted by the administrator to both the storage system 2 and the host computer 1 via the network 5.

The network 4 couples the host computer 1 to the storage system 2 to transfer the I/O request and the like from the host computer 1 to the storage system 2. An optical fiber, a copper wire, and the like are employed for the network 4. In the network 4, a communication protocol such as Fiber Channel, small computer system interface (SCSI), and transmission control protocol/internet protocol (TCP/IP) is used.

The network 5 connects the host computer 1, the storage system 2 and the management terminal 3 to each other. The network 5 communicates management information such as maintenance, configuration, and performance regarding the storage system 2 among the storage system 2, the management terminal 3, and the host computer 1. Both a cable and a communication protocol, which are employed in the network 5, may be the same as those of the network 4, or may be alternatively different from those.

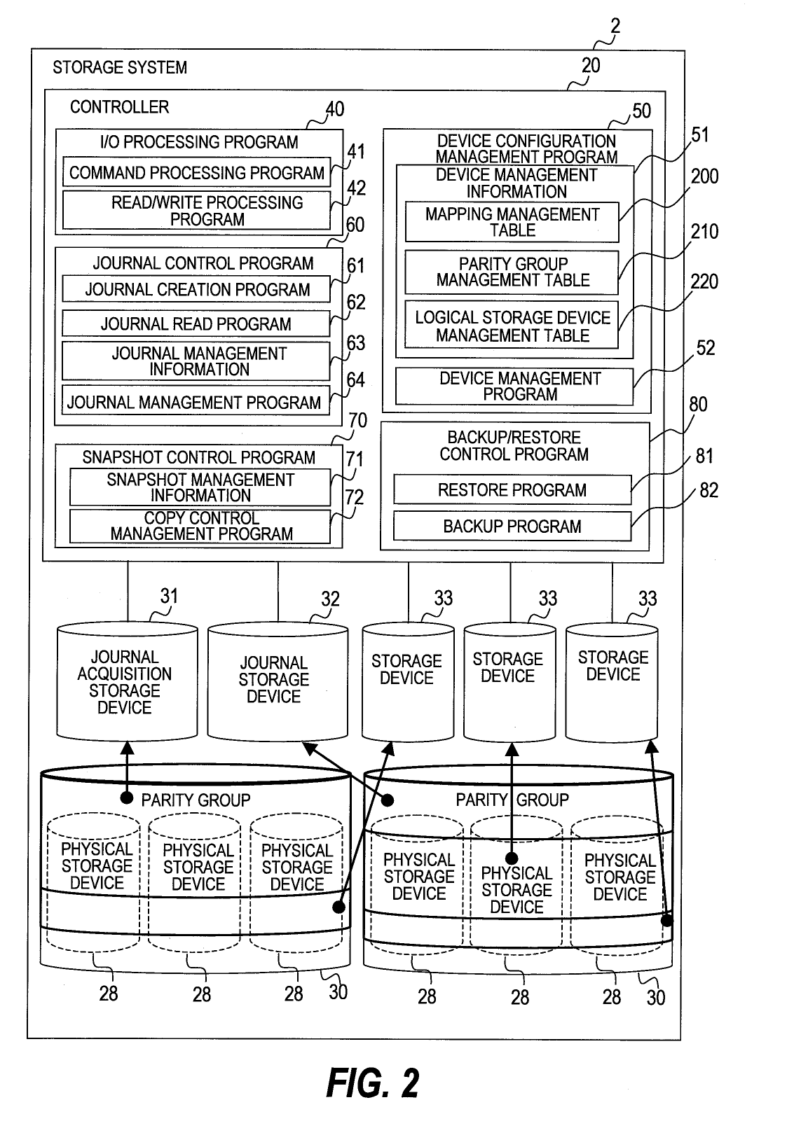

FIG. 2 is a block diagram showing a program configuration and a logical configuration of the storage system 2 in accordance with the first embodiment of this invention.

The storage system 2 combines a single or a plurality of physical storage devices 28 (indicated by dotted lines in FIG. 2) to construct a redundant parity group 30. The parity group 30 is a set of a physical storage device 28 for storing data and a physical storage device 28 for storing parity data which is redundant data generated from the stored data. The storage system 2 constructs the parity group 30 to realize a redundant array of independent disks (RAID) configuration which enables restoration of data even if a failure occurs in the physical storage device 28.

The storage system 2 provides logical storage volumes as logical storage devices journal acquisition storage device 31, journal storage device 32, and storage device 33) from storage volume spaces created by the plurality of physical storage devices 28 constructing the parity group 30 to the host computer 1. The host computer 1 recognizes presence of the logical storage devices 31 to 33.

To control a process of the storage system 2, the controller 20 includes an I/O processing program 40, a device configuration management program 50, a journal control program 60, a snapshot control program 70, and a backup/restoration control program 80 in the nonvolatile memory 24. The controller 20 executes these programs by the processor 21 to control a process described below.

The I/O processing program 40 includes a command processing program 41 and a read/write processing program 42. Upon reception of an I/O processing request from the host computer 1 via the network adaptor 22, the controller 20 executes the command processing program 41 to analyze contents of the received I/O processing request. If a result of the analysis shows that contents of the I/O processing request are a data read I/O (“read I/O” hereinafter) processing request or a data write I/O (“write I/O” ) processing request, the controller 20 executes the read/write processing program 42.

Upon reception of the write I/O processing request, the controller 20 executes response processing to the write I/O processing request from the host computer 1. In the response processing, a response is made as to whether a status has actually been set to enables reception of data transferred from the host computer 1. Subsequently, the controller 20 executes processing of writing transferred update data (“write data” hereinafter) in a predetermined area of the cache memory 26 or the physical storage device 28, or processing of writing the write data stored in the cache memory 26 in the physical storage device 28.

Upon reception of the read I/O processing request, the controller 20 executes processing of reading data (“read data” hereinafter) corresponding to the read I/O processing request from a predetermined area of the cache memory 26 or the physical storage device 28 to transfer it to the host computer 1, or processing of reading the read data from the physical storage device 28 to store it in the cache memory 26.

Upon reception of a processing request other than the write I/O or read I/O processing request, the controller 20 executes the command processing program 41 to execute the requested processing. Specifically, an inquiry command of SCSI (command for instructing device search) or the like is executed.

The device configuration management program 50 includes device management information 51 and a device management program 52.

The device management information 51 contains a mapping management table 200, a parity group management table 210, and a logical storage device management table 220.

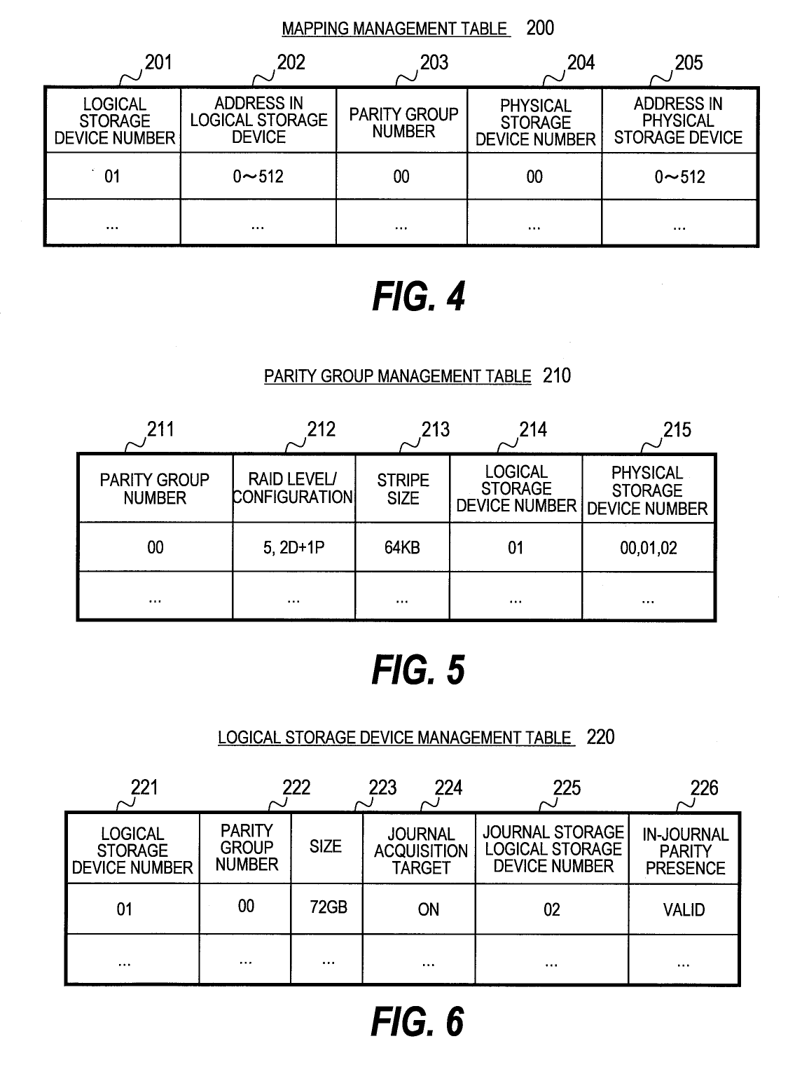

The mapping management table 200 shows a correlation between an address of the logical storage device and an address of the physical storage device 28. The mapping management table 200 will be described below in detail referring to FIG. 4.

The parity group management table 210 stores information regarding the physical storage device 28 constructing the parity group 30. The parity group management table 210 will be described below in detail referring to FIG. 5.

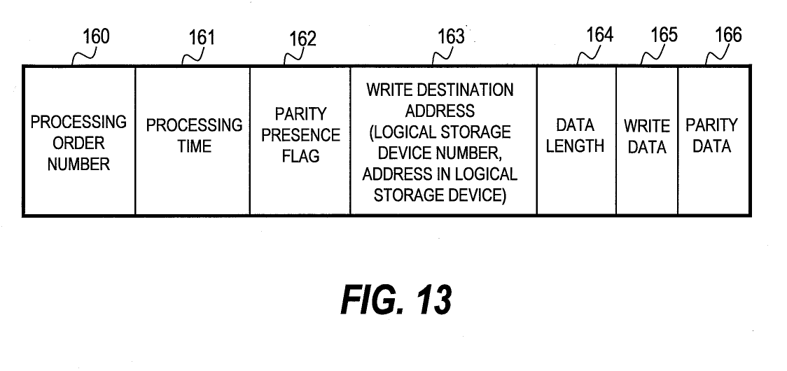

The logical storage device management table 220 stores journal acquisition target information or the like. The term “journal” refers to an update history of data stored in the logical storage device in which journal acquisition has been set. The logical storage device management table 220 will be described below in detail referring to FIG. 6. The journal will be described below referring to FIG. 13.

The device management program 52 is a program executed by the controller 20 to manage the device management information 51. The controller 20 executes the device management program 52 to define a logical storage device, set a logical storage device which stores a snapshot, or register journal acquisition target information based on setting input from the management terminal 3.

The controller 20 executes the device management program 52 to execute data read/write I/O processing. The controller 20 reads read or write data designated by a read/write I/O processing request by executing the device management program 52. The controller 20 calculates an address of the physical storage device 28 corresponding to an address of the logical storage device of an area designated by the read/write I/O processing request, and accesses the physical storage device 28 based on a result of the calculation.

The journal control program 60 includes a journal creation program 61, a journal read program 62, journal management information 63, and a journal management program 64.

The controller 20 executes the journal creation program 61 to create a journal. The controller 20 executes the journal read program 62 to read the created journal.

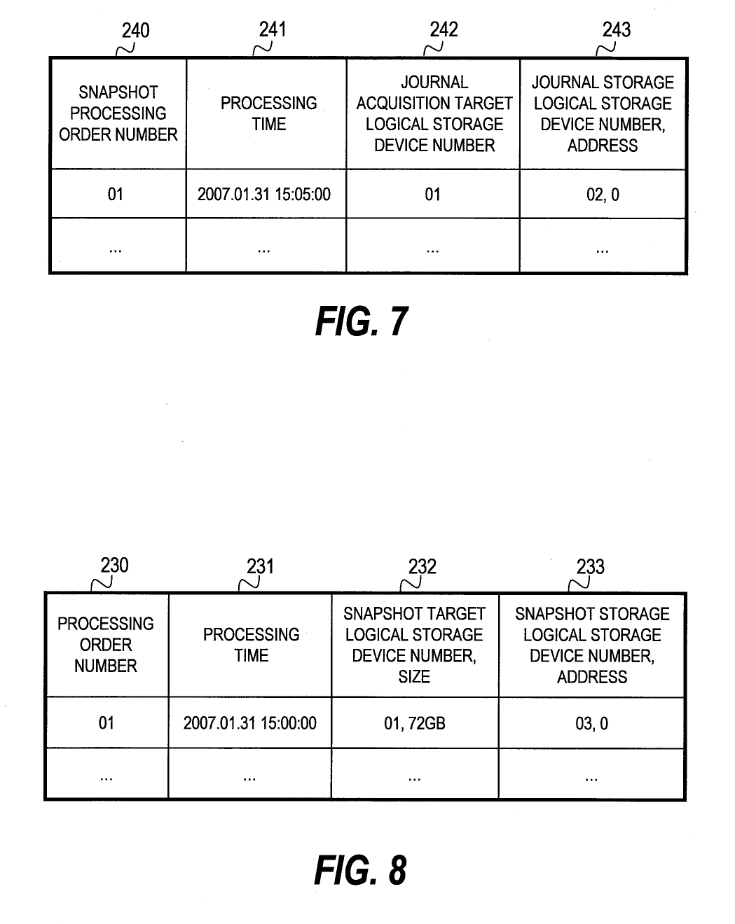

The journal management information 63 is a table for holding information regarding the created journal. The journal management information 63 will be described below in detail referring to FIG. 7. The controller 20 executes the journal management program 64 to set the journal management information 63 or the like.

The controller 20 executes the device management program 52, the journal management program 64, and a copy control management program 72 to set journal acquisition in the logical storage device. At this time, the controller 20 sets whether to contain parity data in the acquired journal based on journal setting input from the management terminal 3 or the like.

The journal acquisition storage device 31 is a logical storage device targeted for journal acquisition setting. The journal storage device 32 is a logical storage device for storing a journal of the journal acquisition storage device 31.

When the journal acquisition storage device 31 receives a write I/O processing request from the host computer 1, the controller 20 executes the read/write processing program 42, the device management program 52, and the journal creation program 61. The controller 20 writes write data in the cache memory 26, and reads data present in an area for storing the write data (will be referred to as “data before write” hereinafter) and corresponding parity data in the parity group 30 (will be referred to as “parity data before write” hereinafter). The controller 20 calculates and creates parity data to be newly written (will be referred to as “write parity data” hereinafter) from the write data, the data before write, and the parity data before write. The controller 20 writes the write data and the write parity data as a journal in an area allocated in the cache memory 26. The journal stored in the cache memory 26 is stored in the journal storage device 32.

The controller 20 executes a restore program 81 and the journal read program 62 to sequentially read the journals stored in the journal storage device 32. The controller 20 overwrites data of the storage volume of the physical storage device 28 constructing a logical storage device which is a restore target indicated by an address of the read journal with the write data and the write parity data contained in the journal.

The snapshot control program 70 includes snapshot management information 71 and a copy control management program 72. The snapshot management information 71 is a table for storing information regarding a snapshot created for the logical storage device. The snapshot management information 71 will be described below in detail referring to FIG. 8.

The copy control management program 72 is a program executed to manage the snapshot management information 71 and to copy data. By executing the copy control management program 72, the controller 20 copies data stored in a certain logical storage device to another logical device to create a snapshot according to an instruction sent from the management terminal 3 or the like, and to register the snapshot in the snapshot management information 71. The controller 20 executes the restore program 81 and the copy control management program 72 to copy the created snapshot to the logical storage device which is a restore target.

The backup/restore control program 80 includes a restore program 81 and a backup program 82. The controller 20 executes the restore program 81 to restore data of a designated logical storage device based on a restore instruction received from the management terminal 3 or the like. By executing the backup program 82, the controller 20 creates a copy of the data stored in the logical storage device or transfers the data of the storage system 2 to the other storage device such as a tape device based on an instruction received from the management terminal 3.

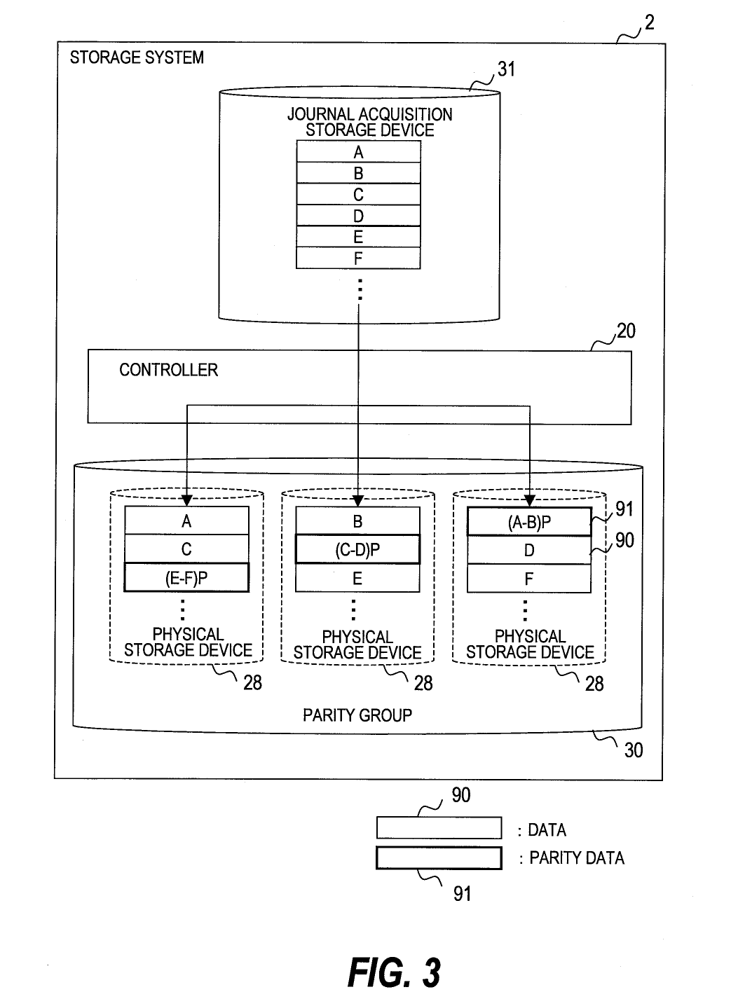

FIG. 3 is an explanatory diagram showing a RAID configuration of the journal acquisition storage device 31 in accordance with the first embodiment of this invention.

The journal acquisition storage device 31 has a RAID 5 configuration which includes three physical storage devices 28. The journal acquisition storage device 31 has a RAID 5 configuration of 2D+1P. Specifically, parity data 91 is stored in one of the three physical storage devices 28, and data 90 is stored in the remaining two physical storage devices 28. The physical storage device 28 is divided into blocks called stripes. The data 90 and the parity data 91 are dispersed by stripes to the physical storage devices to be arranged.

Even when a failure occurs in one of the physical storage devices 28, the journal acquisition storage device 31 can restore data stored in the failed physical storage device 28 based on the data 90 and the parity data 91 stored in the remaining unfailed physical storage devices 28.

Read I/O processing of the RAID 5 configuration can increase a processing speed as it simultaneously accesses a plurality of physical storage devices 28. For example, when data “A” and “B” of the journal acquisition storage device 31 are read, the controller 20 can read both of the data “A” and “B” by simultaneously accessing the two physical storage devices 28.

On the other hand, write I/O processing of the RAID 5 configuration has to execute regeneration of parity data and writing of the generated parity data, in addition to the write processing with respect to the physical storage device 28.

Because the parity data is generated from a plurality of data of one stripe portion of the parity group 30, the parity data has to be regenerated for each updating of data. For example, the parity data is calculated by an equation of “write parity data=(data before write XOR write data) XOR parity data before write”. The XOR is one of logical calculations, and called exclusive OR.

According to the equation, regeneration of the parity data needs data before write, parity data before write, and write data. Thus, to regenerate parity data, processing of reading the data before write and the parity data before write has to be carried out. A delay of the write I/O processing caused by this reading processing is called a write penalty.

Thus, as the write I/O processing is accompanied by the write penalty, write I/O processing performance of small random data is reduced while no problem occurs in the case of continuous data. Specifically, when write data “A” is written in a position of data “A” of the journal acquisition storage device 31, the controller 20 accesses the two physical storage devices 28 to read the data “A” before write and corresponding parity data “(A-B)P” before write in areas allocated in the cache memory 26. Subsequently, the controller 20 regenerates new write parity data “(A-B)P” from the data “A” before write, the parity data “(A-B)P” before write and the write data “A”. The controller 20 writes the write data “A” and the write parity data “(A-B)P” in the cash memory 26 or the physical storage device 28.

The journal acquisition storage device 31 may have a RAID 5 configuration which includes four or more physical storage devices. The journal acquisition storage device 31 may have a RAID 6 configuration which includes four or more physical storage devices, uses the two independent physical storage devices thereof for saving the parity data, and disperses data to the remaining physical storage devices to write therein.

FIG. 4 is an explanatory diagram showing the mapping management table 200 included in the device management information 51 in accordance with the first embodiment of this invention. The mapping management table 200 includes a logical storage device number 201, an address 202 in the logical storage device 202, a parity group number 203, a physical storage device number 204, and an address 205 in the physical storage device.

A record of the mapping management table 200 stores a correlation between a logical storage volume specified by a logical storage device number 201 and an address 202 in the logical storage device and a physical storage volume specified by a physical storage device number 204 and an address 205 in the physical storage device.

The logical storage device number 201 is a number for identifying a logical storage volume provided to the host computer 1. The address 202 in the logical storage device is an address in the logical storage device specified by the logical storage device number 201.

The parity group number 203 is a number for identifying a parity group to which a logical storage device belongs.

The physical storage device number 204 stores a number for identifying a physical storage device 28 in which the logical storage volume specified by the logical storage device number 201 and the address 202 in the logical storage device. The address 205 in the physical storage device stores an address in the physical storage device 28 in which the logical storage volume is created.

FIG. 5 is an explanatory diagram showing the parity group management table 210 included in the device management information 51 in accordance with the first embodiment of this invention. In the parity group management table 210, one record is created for each parity group.

The parity group management table 210 includes a parity group number 211, a RAID level/configuration 212, a stripe size 213, a logical storage device number 214, and a physical storage device number 215.

The parity group number 211 stores an identifier for identifying a parity group 30. The RAID level/configuration 212 stores a RAID level and configuration. For example, “5, 2D+1P” shown in FIG. 5 indicates a RAID 5 configuration in which data are stored in the two physical storage devices 28, and parity data is stored in one physical storage device 28. The stripe size 213 is a unit capacity for dispersing and arranging data and parity data in the parity group.

The logical storage device number 214 is an identifier for identifying a logical storage device which belongs to a parity group. The physical storage device number 215 is an identifier for identifying a physical storage device 28 which constructs a parity group.

FIG. 6 is an explanatory diagram showing the logical storage device management table 220 included in the device management information 51 of the device configuration management program 50 in accordance with the first embodiment of this invention. In the logical storage device management table 220, one record is created for one logical storage device.

The logical storage device management table 220 includes a logical storage device number 221, a parity group number 222, a size 223, a journal acquisition target 224, a logical storage device number 225 for storing a journal, and parity presence 226 in a journal.

The logical storage device number 221 is an identifier for identifying a logical storage device. The parity group number 222 is an identifier for identifying a parity group 30 in which a logical storage device is created. The size 223 is a storage capacity of a logical storage device.

The journal acquisition target 224 indicates whether a logical storage device is a target for obtaining a journal. Specifically, if the logical storage device is a journal acquisition target, “ON” is stored. On the other hand, if the logical storage device is not a journal acquisition target, “OFF” is stored.

The logical storage device number 225 for storing a journal stores an identifier for identifying a logical storage device in which the journal of the logical storage device is recorded. The parity presence 226 in a journal indicates whether to contain parity data in the journal.

FIG. 7 is an explanatory diagram showing an example of the journal management information 63 included in the journal control program 60 in accordance with the first embodiment of this invention. In the journal management information 63, one record is created when after a snapshot is created, a journal regarding a journal acquisition target logical storage device as a creation target of the snapshot is created for the first time.

The journal management information 63 contains a snapshot processing order number 240, processing time 241, a journal acquisition target logical storage device number 242, and a journal storage logical storage device number/address 243.

The snapshot processing order number 240 is given in order that snapshots are created, and identifies each created snapshot. The processing time 241 is time when a first journal regarding the journal acquisition target logical storage device as the snapshot creation target is created.

The journal acquisition target logical storage device number 242 stores an identifier for identifying the journal acquisition target logical storage device which is the journal creation target. The journal storage logical storage device number/address 243 stores an identifier and an address of a logical storage device which stores the journal.

FIG. 8 is an explanatory diagram showing an example of the snapshot management information 71 included in the snapshot control program 70 in accordance with the first embodiment of this invention.

The snapshot management information 71 contains a processing order number 230, processing time 231, a snapshot target logical storage device number/size 232, and a snapshot storage logical storage device number/address 233.

The processing order number 230 is each of identification numbers added in a snapshot created order. The processing time 231 is time when a snapshot is created.

The snapshot target logical storage device number/size 232 stores an identifier for identifying a logical storage device of a snapshot acquisition target, and a size of a storage volume of the acquisition target.

The snapshot storage logical storage device number/address 233 stores an identifier for identifying a logical storage device which stores a created snapshot, and a start address of an area in which the snapshot is stored.

The configuration of the first embodiment of this invention has been described. A process of the first embodiment of the invention will be described below.

First, an outline of the process of the first embodiment of this invention will be given.

Upon reception of a write I/O processing request in the journal acquisition storage device 31, the controller 20 of the storage system 2 writes write data in the cache memory 26. The controller 20 reads data before write and parity data before write to regenerate write parity data.

The controller 20 writes the write data and the write parity data in the cache memory 26 or the physical storage device 28, and creates a journal containing the write data and the write parity data to write it in the cache memory 26 or the physical storage device 28 of the journal storage device 32.

Upon reception of a restore instruction of the journal acquisition storage device 31 containing a restore point, the controller 20 restores a snapshot of the journal acquisition storage device 31 created beforehand. The controller 20 sequentially reads journals recorded in the journal storage device 32 from the time of snapshot creation to the restore point. The controller 20 overwrites data of the storage volume of the physical storage device 28 constructing the logical storage device of a restore target with write data and write parity data contained in the read journals.

Accordingly, the storage system 2 can restore the data stored in the journal acquisition storage device 31 at a high speed without any write penalties.

The process of the first embodiment of this invention will be described below in detail.

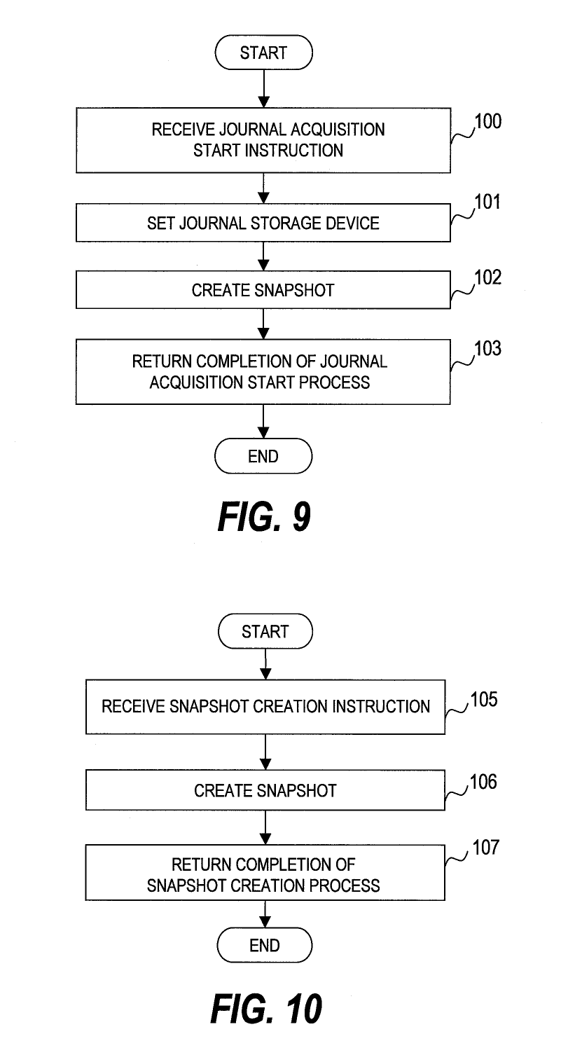

FIG. 9 is a flowchart showing a procedure of a journal acquisition start process in accordance with the first embodiment of this invention. This process is executed when the management terminal 3 or the host computer 1 transmits a journal acquisition start instruction to the storage system 2, and the storage system 2 receives the journal acquisition start instruction.

According to the first embodiment, a logical storage device in which data used by AP of the host computer 1 has been stored is designated as a journal acquisition storage device 31.

The journal acquisition start instruction contains identification information of the journal acquisition storage device 31 for setting journal acquisition, identification information of a logical storage device which stores a snapshot of data stored in the journal acquisition storage device 31 at the moment of receiving the journal acquisition start instruction, and identification information of a journal storage device 32 for storing a journal regarding the journal acquisition storage device 31. The journal acquisition start instruction further contains setting information regarding whether to contain parity data in a journal to be obtained.

The logical storage device for storing the snapshot and the journal storage device 32 may be the same.

First, the controller 20 of the storage system 2 receives a journal acquisition start instruction from the management terminal 3 or the host computer 1 (step 100).

The controller 20 sets a designated journal storage device 32 based on the received journal acquisition start instruction (step 101). Specifically, first, the controller 20 refers to the device management information 51 to check whether the device is a usable logical storage device based on identification information of the journal storage device 32 contained in the journal acquisition start instruction. For example, for judgment as to usability of the logical storage device, whether the designated logical storage device exists, or whether the designated logical storage device has been used for other processing is checked.

Next, if the designated journal storage device 32 is usable, the controller 20 registers information regarding the designated journal storage device 32 in the device management information 51. Specifically, the controller 20 registers the information in the logical storage device table 220 of the device management information 51 so that a journal of the journal acquisition storage device 31 can be stored in the designated journal storage device 32. Further, setting information as to whether the journal contains parity data is registered in the in-journal parity presence 226 of the logical storage device management table 220.

The controller 20 creates a snapshot based on the received journal acquisition start instruction (step 102). Specifically, first, the controller 20 refers to the device management information 51 to check whether the device is a usable logical storage device based on identification information of a snapshot storage logical storage device contained in the journal acquisition start instruction.

Next, if the designated logical storage device is usable, the controller 20 executes a snapshot creation process. The controller 20 sequentially copies data stored in the journal acquisition storage device 31 at the time of receiving the journal acquisition start instruction in the snapshot storage logical storage device.

When the snapshot creation is finished, the controller 20 registers information regarding the created snapshot in the snapshot management information 71.

Upon completion of the journal acquisition process, the controller 20 notifies it to the management terminal 3 or the host computer 1 which has issued the journal acquisition start instruction (step 103).

The snapshot creation processing may be executed beforehand by an instruction different from the journal acquisition start instruction, for example, a snapshot creation process of FIG. 5 described below.

FIG. 10 is a flowchart showing a procedure of the snapshot creation process in accordance with the first embodiment of this invention. This process is executed when the management terminal 3 or the host computer 1 transmits a snapshot creation instruction to the storage system 2, and the storage system 2 receives the snapshot creation instruction.

According to the first embodiment of this invention, a logical storage device which has stored data used by the AP of the host computer 1 is designated as a primary logical storage device. The snapshot creation instruction contains identification information of the primary logical storage device, and identification information of a backup logical storage device which stores a snapshot of data stored in the primary logical storage device.

First, the controller 20 of the storage system 2 receives a snapshot creation instruction from the management terminal 3 or the host computer 1 (step 105).

Next, the controller 20 creates a snapshot (step 106). Specifically, first, the controller 20 refers to the device management information 51 to check whether the device is a usable logical storage device by using identification information of a snapshot storage logical storage device contained in the snapshot creation instruction.

If the designated logical storage device is usable, the controller 20 executes a snapshot creation process. Specifically, the controller 20 sequentially copies data stored in the primary logical storage device at the time of receiving the snapshot creation instruction in the snapshot storage logical storage device. When the snapshot creation is finished, the controller 20 registers information regarding the created snapshot in the snapshot management information 71.

Upon completion of the snapshot creation process, the controller 20 notifies it to the management terminal 3 or the host computer 1 which has issued the snapshot creation instruction (step 107).

The snapshot creation process may be executed at optional timing after journal acquisition setting is carried out in a logical storage device of a snapshot acquisition target.

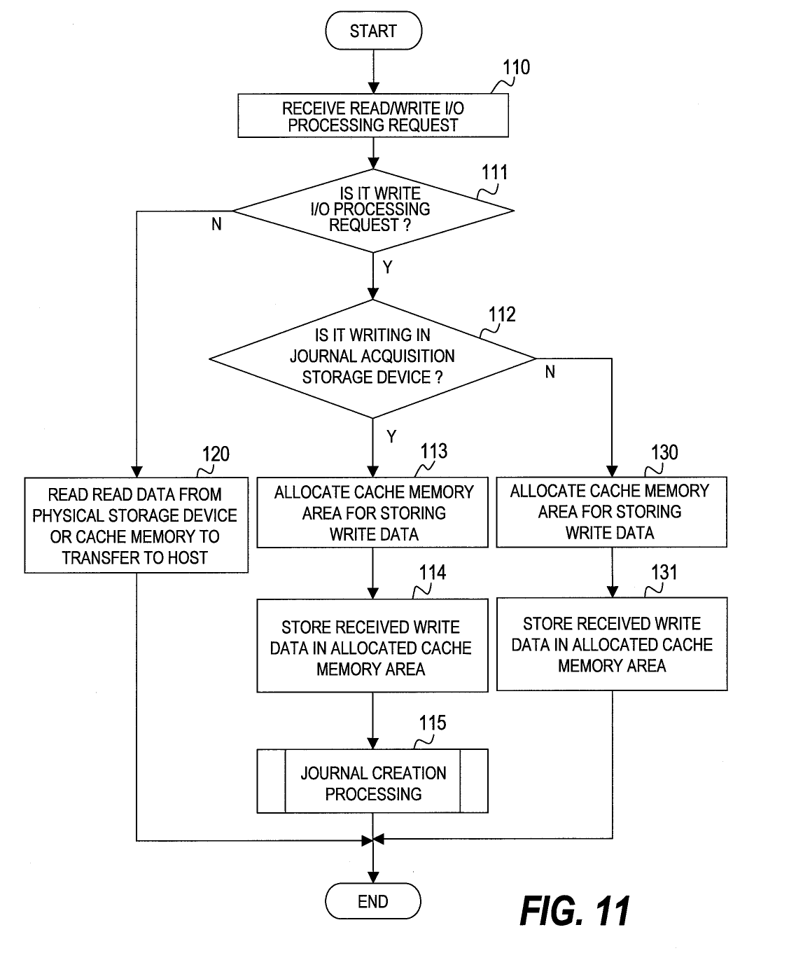

FIG. 11 is a flowchart showing a read/write I/O processing procedure in accordance with the first embodiment of this invention. This process is carried out when the storage device 2 receives a read/write I/O processing request from the host computer 1 or the management terminal 3.

Upon reception of a read I/O processing request or a write I/O processing request from the host computer 1 (step 110), the controller 20 judges whether the received processing request is a write I/O processing request (step 111).

If the request is not a write I/O processing request (result of the step 111 is “N”), the controller 20 refers to the device management information 51 to read data which is a target of a read I/O processing request from the corresponding physical storage device 28 or cache memory 26, and to transfer it to the host computer 1 via a network adaptor 22 (step 120).

If the received processing request is a write I/O processing request, (result of the step 111 is “Y”), the controller 20 refers to the device management information 51 to judge whether a logical storage device specified by the write I/O processing request is a journal acquisition storage device 31 (step 112).

If the logical storage device designated by the write I/O processing request is not a journal acquisition storage device 31 (result of the step 112 is “N”), the controller 20 allocates an area for storing write data accompanying the write I/O processing request in the cache memory 26 (step 130). Then, the controller 20 stores the write data in the allocated area of the cache memory 26, and notifies completion of the write I/O process (step 131).

The controller 20 may notify to the host computer 1, the end of the write I/O process after storage of data from the cache memory 26 into the physical storage device 28. The write data may directly be stored in the physical storage device 28 without using the cache memory 26.

If the logical storage device designated by the write I/O processing request is a journal acquisition storage device 31 (result of the step 112 is “Y”), the controller 20 allocates an area for storing write data in the cache memory 26 (step 113), and stores the write data transmitted from the host computer 1 in the area (step 114).

Different from writing of write data in the normal logical storage device, in the case of continuous writing of write data in which the same address as that of the journal acquisition storage device 31 is designated, the controller 20 stores respective write data in different areas of the cache memory 26.

The controller 20 executes a journal creation process to notify the completion of the write I/O process to the host computer 1 (step 115).

The controller 20 may notify the completion of the write I/O process without waiting for completion of the journal creation processing to the host computer 1. The controller 20 may asynchronously execute the journal creation process after the completion of the write I/O process is notified to the host computer 1 after the write data of the step 114 is stored in the cache memory 26.

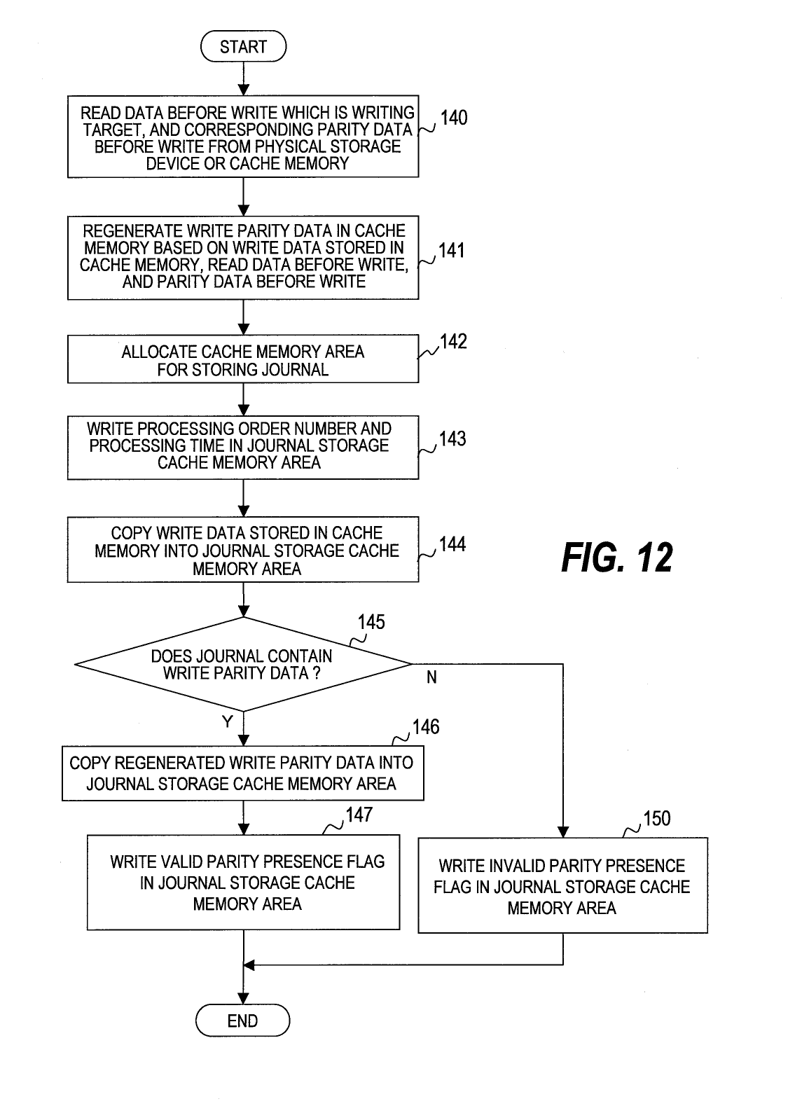

FIG. 12 is a flowchart showing a procedure of a journal creation process in accordance with the first embodiment of this invention. This process corresponds to the processing of the step 115 of FIG. 11.

The controller 20 stores write data in the cache memory 26, and then reads the data before write present in the area for storing the write data, and the corresponding parity data before write in the parity group 30 from the cache memory 26 or the physical storage device 28 (step 140).

The controller 20 recreates write parity data to be newly written in the area of the cache memory 26 based on the write data, the read data before write and parity data before write (step 141).

The controller 20 allocates an area for storing a journal in the cache memory 26 (step 142). The controller 20 refers to the device management information 51 to check whether to contain parity data in a journal to be created, and allocates a journal storage area in the cache memory 26 according to presence of parity data.

The controller 20 writes a processing order number added for each execution of processing by the processor 21 and processing time of receiving a write I/O process in the journal storage area allocated in the cache memory 26 (step 143).

The controller 20 copies the write data stored in the cache memory 26 to the journal storage area allocated in the cache memory 26 (step 144).

The controller 20 refers to the device management information 51 to judge whether to contain parity data in a journal to be created (step 145).

If no parity data is contained (result of the step 145 is “N”), the controller 20 invalidates a parity presence flag indicating whether to contain parity data to write it in the journal storage area allocated in the cache memory 26, and then finishes the process (step 150).

If parity data is contained (result of the step 145 is “Y”), the controller 20 copies the write parity data regenerated in the cache memory 26 to the journal storage area allocated in the cache memory 26 (step 146).

The controller 20 validates the parity presence flag to write it in the journal storage area allocated in the cache memory 26, and finishes the process (step 147).

The write data, the write parity data, and the journal stored in the cache memory 26 are written from the cache memory 26 in the physical storage device 28 asynchronously with the storage of the data in the cache memory 26.

In the case of creating a journal regarding the journal acquisition storage device 31 for the first time after creation of a snapshot of the journal acquisition storage device 31, the controller 20 registers information regarding the journal to be created in the journal management information 63.

FIG. 13 is a diagram showing a journal data form in accordance with the first embodiment of this invention.

As described above referring to FIGS. 11 and 12, a journal is created in the cache memory each time the storage system 2 processes the write I/O processing request to the journal acquisition storage device 31, and then stored in the physical storage device 28.

The journal contains a processing order number 160, processing time 161, a parity presence flag 162, write destination address 163, a data length 164, write data 165, and parity data 166.

The processing order number 160 is a number added for each journal creation. The processing order number 160 identifies a journal. In the processing time 161, time of writing write data 165 is stored. In the parity presence flag 162, a flag for identifying whether to contain parity data in a journal is stored.

The write destination address 163 stores a logical storage device number for storing the write data 165, and an address in a logical storage device. The data length 164 stores a data length of the write data 165. The write data 165 is write data itself accompanying the write I/O processing request. The parity data 166 is write parity data recreated corresponding to the write data 165.

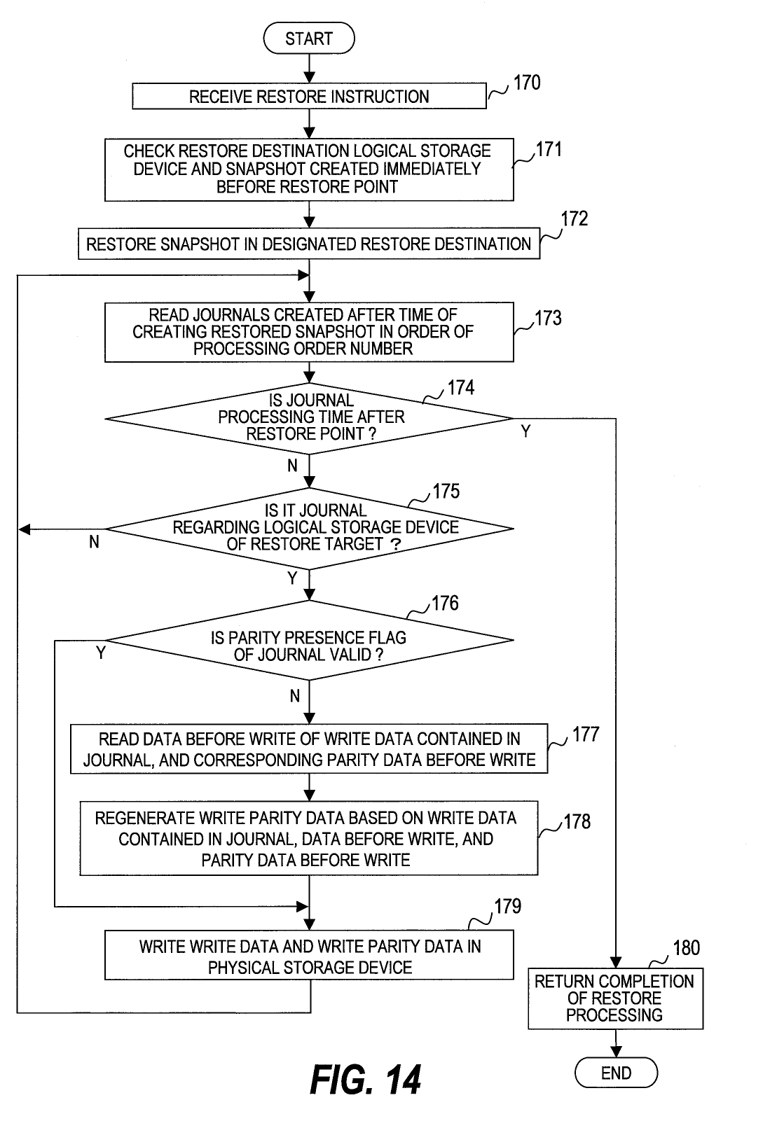

FIG. 14 is a flowchart showing a procedure of a restore process in accordance with the first embodiment of this invention. This process is executed by the storage system 2 which has received a restore instruction from the management terminal 3 or the host computer 1.

The first embodiment of this invention will be described by way of a restore process carried out when a bug of the AP or administrator's operation mistake causes logical inconsistency in data stored in the journal acquisition storage device 31.

First, the administrator refers to log information of the AP to analyze the time of logical inconsistency occurrence, thereby deciding a restore point to restore data. Then, a restore instruction is transmitted from the management terminal 3 or the host computer 1 to the storage system 2. The restore instruction contains identification information of a logical storage device which has stored data to be restored, identification information of a restore destination logical storage device, and a restore point.

According to the first embodiment of this invention, the journal acquisition storage device 31 is designated as a logical storage device which has stored data to be restored, and the journal acquisition storage device 31 is designated as a restore destination logical storage device.

Upon reception of a restore instruction from the management terminal 3 or the host computer 1 (step 170), the controller 20 of the storage system 2 refers to the device management information 51 based on identification information of a logical storage device designated as a restore destination and contained in the restore instruction. The controller 20 checks whether the designated logical storage device is a logical storage device usable as a restore destination (step 171). In this case, the controller 20 checks whether the restore destination logical storage device and the logical storage device which has stored the data to be restored have similar RAID configuration.

Based on the identification information of the logical storage device which has stored the data to be restored and contained in the restore instruction, the controller 20 refers to the snapshot management information 71 and the journal management information 63 to check whether the designated data can be restored. The controller 20 compares the restore point contained in the restore instruction with the snapshot management information 71, and checks a latest snapshot among snapshots of the restore target logical storage device at time before the restore point.

If a result of the checking shows a certain failure, the controller 20 notifies inhibition of continued processing due to the failure to the management terminal 3 or the host computer 1 which has issued the restore instruction, and cancels the process.

The controller 20 reads a snapshot of the restore target logical storage device created immediately before the restore point from the logical storage device which has stored the snapshot to copy it to the restore destination logical storage device (step 172). According to the first embodiment of this invention, the snapshot of the journal acquisition storage device 31 created immediately before the restore point is restored in the journal acquisition storage device 31. If the logical storage device which has stored the snapshot is designated as a restore destination, this copy processing is unnecessary.

The controller 20 allocates a data storage area in the cache memory 26. The controller 20 refers to the journal management information 63 to obtain a journal storage address of the journal acquisition storage device 31 created immediately after the creation of the restored snapshot. The controller 20 sequentially reads journals in an order of processing order numbers from the obtained journal storage addresses to the area allocated in the cache memory 26 (step 173).

The controller 20 judges whether the processing time contained in the read journal is time after the restore point (step 174).

If the processing time of the read journal is not after the restore point (result of the step 174 is “N”), the controller 20 judges whether the read journal is a journal regarding the journal acquisition storage device 31 designated as a restore target (step 175).

If the read journal is not a journal regarding the journal acquisition storage device 31 designated as the restore target (result of the step 175 is “N”), the controller 20 returns to the processing of the step 173.

If the read journal is a journal regarding the journal acquisition storage device 31 designated as the restore target (result of the step 175 is “Y”), the controller 20 judges whether a parity presence flag contained in the journal is valid (step 176).

If the parity presence flag contained in the journal is valid (result of the step 175 is “Y”), the controller 20 writes write data and write parity data contained in the journal in the cache memory 26 or the physical storage device 28 (step 179).

If the parity presence flag contained in the journal is not valid (result of the step 175 is “N”), the controller 20 reads data before write present in the area for storing the write data contained in the journal and corresponding write parity data before write in the parity group 30 from the cache memory 26 or the physical storage device 28 (step 177).

The controller 20 regenerates write parity data to be newly written in the area of the cache memory 26 based on the write data contained in the journal and the read data before write and parity data before write (step 178).

Subsequently, the controller 20 writes the write data contained in the journal and the regenerated write parity data in the cache memory 26 or the physical storage device 28 (step 179).

Upon completion of the processing of the step 179, the controller 20 returns to the step 173 to read a next journal. The controller 20 repeats the process from the step 173 to the step 179 to apply the journal up to the designated restore point, thereby restoring data.

If the processing time of the read journal is after the restore point (result of the step 174 is “Y”), the controller 20 judges that the data to be restored have all been written in the restore destination journal acquisition storage device 31, and notifies completion of the restore process to the management terminal 3 or the host computer 1 which has issued the restore instruction.

The controller 20 may asynchronously execute the steps 177 and 178 after the write data contained in the journal is stored in the cache memory 26. The write data and the write parity data stored in the cache memory 26 are written from the cache memory 26 into the physical storage device 28 asynchronously with the storage of the data in the cache memory 26.

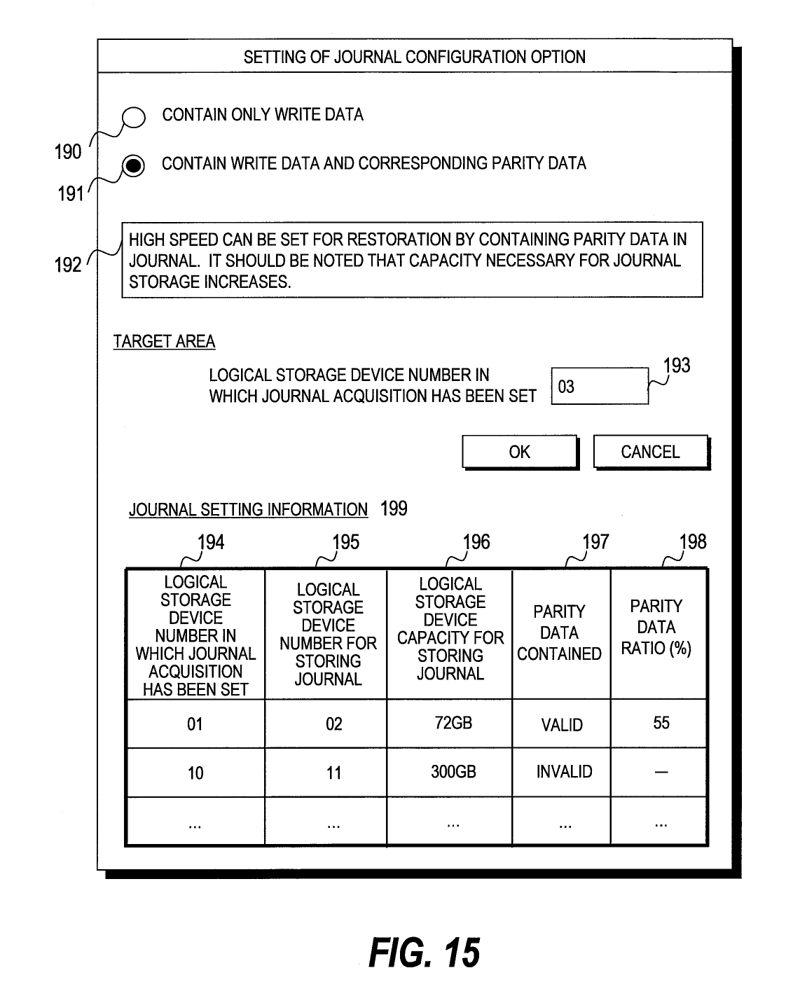

FIG. 15 is an explanatory diagram showing an example of a setting screen of a journal configuration option in accordance with the first embodiment of this invention. The setting screen of the journal configuration option is a user interface for setting whether to contain parity data in a journal. The setting screen of the journal configuration option is displayed in the management terminal 3 or the host computer 1 by the controller 20.

The administrator can set whether to contain parity data in a journal for a specific journal acquisition storage device 31. Specifically, setting is reflected in the storage system 2 by selecting a check box 191, inputting an identification number of a journal acquisition storage device 31 of a setting target to a character input area 193, and operating an “OK” button.

On the other hand, by selecting the check box 190, the administrator can set noninclusion of parity data in a journal. When inclusion of parity data in a journal is set, the controller 20 may display a message indicating a function or an effect in a display unit 192. For example, as shown in FIG. 15, a message that a capacity necessary for storing the journal increases while a high speed is achieved for restoration can be displayed.

In the setting screen of the journal configuration option, journal setting information 199 regarding a logical storage device in which journal acquisition has been set may be displayed.

The journal setting information 199 contains a logical storage number 194 in which journal acquisition has been set, a journal storage logical storage device number 195, a journal storage logical storage device capacity 196, parity data contained 197, and a parity data ratio 198.

The logical storage device number 194 in which the journal acquisition has been set stores a logical storage device number for identifying a logical storage device whose journal is obtained. The journal storage logical storage device 195 stores a logical storage device number for identifying a logical storage device which stores a created journal regarding the logical storage device identified by the logical storage device number 194 in which the journal acquisition has been set. The journal storage logical storage device capacity 196 stores a storage capacity of the logical storage device identified by the journal storage logical storage device number 195.

The parity data contained 197 stores information for identifying whether parity data is contained in a journal. The parity data ratio 198 is a ratio of parity data contained in the journal storage logical storage device capacity 196.

According to the first embodiment of this invention, by creating a journal which contains write data and write parity data, the data stored in the journal acquisition storage device 31 can be restored at a high speed without any write penalties. Especially, the embodiment is effective for AP which has many small random write I/O processing requests as in the case of DBMS.

Furthermore, according to the first embodiment of this invention, as write parity data is generated by being contained in a journal by extension of the write I/O process, a load on the storage system 2 can be reduced.

### Second Embodiment

The first embodiment has been described by way of case where the invention is applied to one storage system. However, a second embodiment is directed to a case where the invention is applied to a remote copy system. Components having functions similar to those of the first embodiment are denoted by similar reference numerals, and description thereof will be omitted.

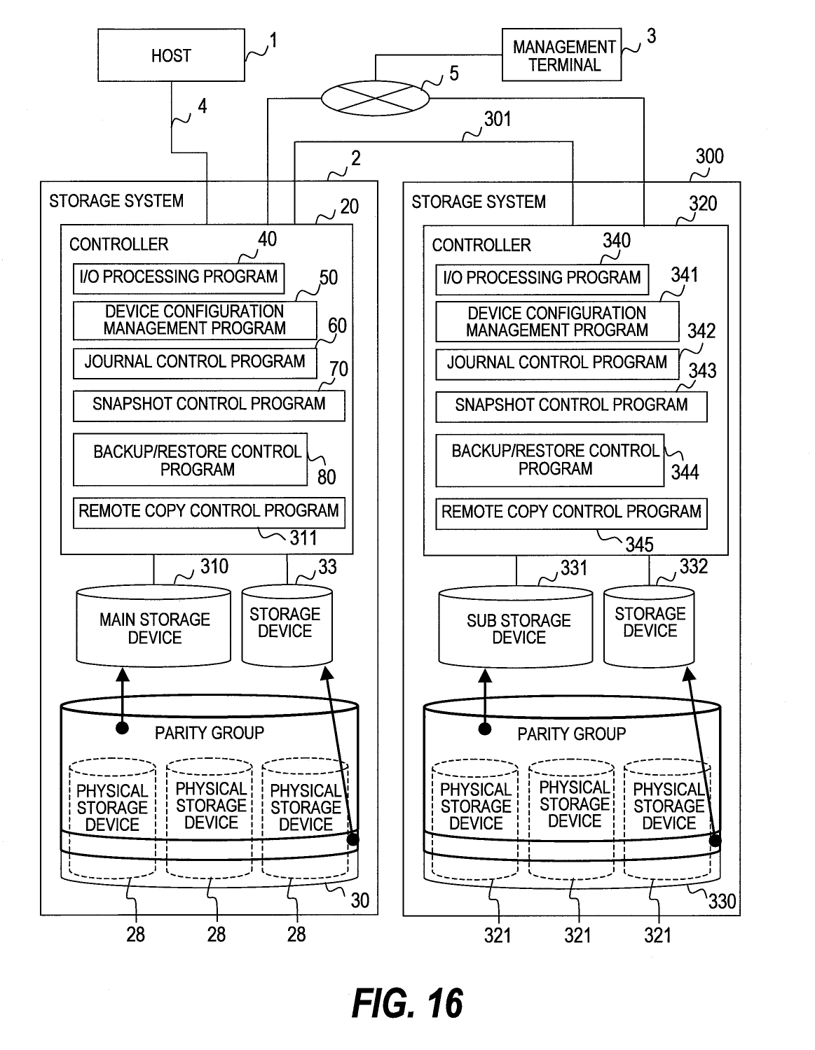

FIG. 16 is a block diagram showing a hardware configuration and a logical configuration of a remote copy system in accordance with the second embodiment of this invention.

As in the case of the first embodiment, the remote copy system of the second embodiment of this invention includes a host computer 1, a storage system 2, a management terminal 3, networks 4 and 5, a storage system 300, and a network 301.

The remove copy system of the second embodiment of this invention transfers data stored in the storage system 2 to the storage system 300 via the network 301 to copy it.

A hardware configuration of the storage system 2 includes a dedicated network adaptor for connecting the storage system 2 to the network 301 in a controller 20 in addition to the components of the first embodiment.

A hardware configuration of the storage system 300 is similar to that of the storage system 2, and includes a dedicated network adaptor for connecting the storage system 300 to the network 301 in the controller 20 in addition to the hardware components of the storage system 2 of the first embodiment.

The network 301 is used for interconnecting the storage systems 2 and 3, and transmitting a remote copy processing request from the storage system 2 to the storage system 300.

An optical fiber or a copper wire is used for a cable of the network 301. For communication protocol used for the network 301, communication protocol of a fibre channel, SCSI, or TCP/IP is used. The network 301 may be similar to or different from the networks 4 and 5.

A logical configuration of the storage system 2 is almost similar to that of the first embodiment. Differences will be described below.

The storage system 2 provides a logical storage volume as a logical storage device (main storage device 310, or storage device 33) from a storage volume area constructed of a plurality of physical storage devices 28 of a parity group 30 to the host computer 1.

The main storage device 310 is a logical storage device set as a primary target of a remote copy process.

The controller 20 includes a remote copy control program 311 in a nonvolatile memory 24 to control the remote copy process. The controller 20 executes the remote copy control program 311 by a processor 21 to execute a remote copy start preparation process or a remote copy process.

A logical configuration of the storage system 300 is almost similar to that of the storage system 2.

The storage system 300 provides a logical storage volume as a logical storage device (sub storage device 331, or storage device 332) from a storage volume space constructed of a plurality of physical storage devices 321 of a parity group 330.

The sub storage device 331 is a logical storage device set as a backup storage device of a remote copy process.

A controller 320 stores an I/O processing program 340, a device configuration management program 341, a journal control program 342, a snapshot control program 343, and a backup/restore control program 344 in a nonvolatile memory of the controller 320 to control a process in the storage system 300.

To control the remote copy process, the controller 320 stores a remote copy control program 345 in the nonvolatile memory of the controller 320.

The controller 320 executes theses programs by the processor 21 to control a process in the storage system 300 and the remote copy process.

Upon reception of a remote copy start preparation from the management terminal 3 or the like, the controller 20 executes a remote copy control program 311, a device configuration management program 50, a journal control program 60, and a snapshot control program 70. Similarly, the controller 320 executes the remote copy control program 345, the device configuration management program 341, the journal control program 342, and the snapshot control program 343.

The controller 20 sets the main storage device 310 as a primary logical storage device of the remote copy process. The controller 320 sets the sub storage device 331 as a backup logical storage device of the remote copy process.

In this case, the controller 20 sets whether to contain parity data in a journal to be obtained according to remote copy transfer journal setting input from the management terminal 3.

Subsequently, the controller 20 creates snapshots of the main storage device 310 to transfer them to the storage system 300. The controller 320 sequentially writes the transferred snapshots in the sub storage device 331.

Upon reception of a write I/O processing request from the host computer 1 to the main storage device 310, the controller 20 executes a read/write processing program 42, a device management program 52, a journal creation program 61, and the remote copy control program 311.

The controller 20 writes write data in the cache memory 26, and reads data before write present in an area for storing the write data and corresponding parity data before write in the parity group 30.

The controller 20 regenerates new write parity data to be written based on the write data, and the read data before write and parity data before write.

The controller 20 writes the write data and the write parity data as a journal in an area allocated in the cache memory 26.

The controller 20 transmits an instruction of transferring the journal created in the cache memory 26 to the storage system 300, and restoring the transferred journal in the sub storage device 331.

Upon reception of the instruction of restoring the transferred journal, the controller 320 executes the backup/restore control program 344, the journal control program 342, and the remote copy control program 345.

The controller 320 overwrites data in a storage volume of the physical storage device 321 of the sub storage device 331 with the write data and the write parity data contained in the journal.

The storage system 2 may temporarily write the journal to be transferred from the cache memory 26 into the storage device 33. Similarly, the storage system 300 may temporarily write the transferred journal from the cache memory into the storage device 332.

A process outline of the second embodiment of this invention will be described below based on the aforementioned configuration.

Upon reception of a write I/O processing request in the main storage device 310, the controller 20 of the storage system 2 writes write data in the cache memory 26. The controller 20 reads data before write and parity data before write to regenerate write parity data.

The controller 20 writes the write data and the write parity data in the cache memory 26 or the physical storage device 28, and creates a journal containing the write data and the write parity data to write the journal in the cache memory 26. The controller 20 gives an instruction of transferring the journal of the cache memory 26 to the storage system 300 to restore it in the sub storage device 331.

Upon reception of a restore instruction of the transferred journal, the controller 320 of the storage system 300 overwrites data in the storage volume of the physical storage device 321 of the sub storage device 331 which is a backup device of the main storage device 310 with the write data and the write parity data contained in the transferred journal.

Accordingly, the remote copy system of the embodiment 2 can restore the data stored in the main storage device 310 in the sub storage device 331 at a high speed without any write penalties.

Each process will be described below in detail.

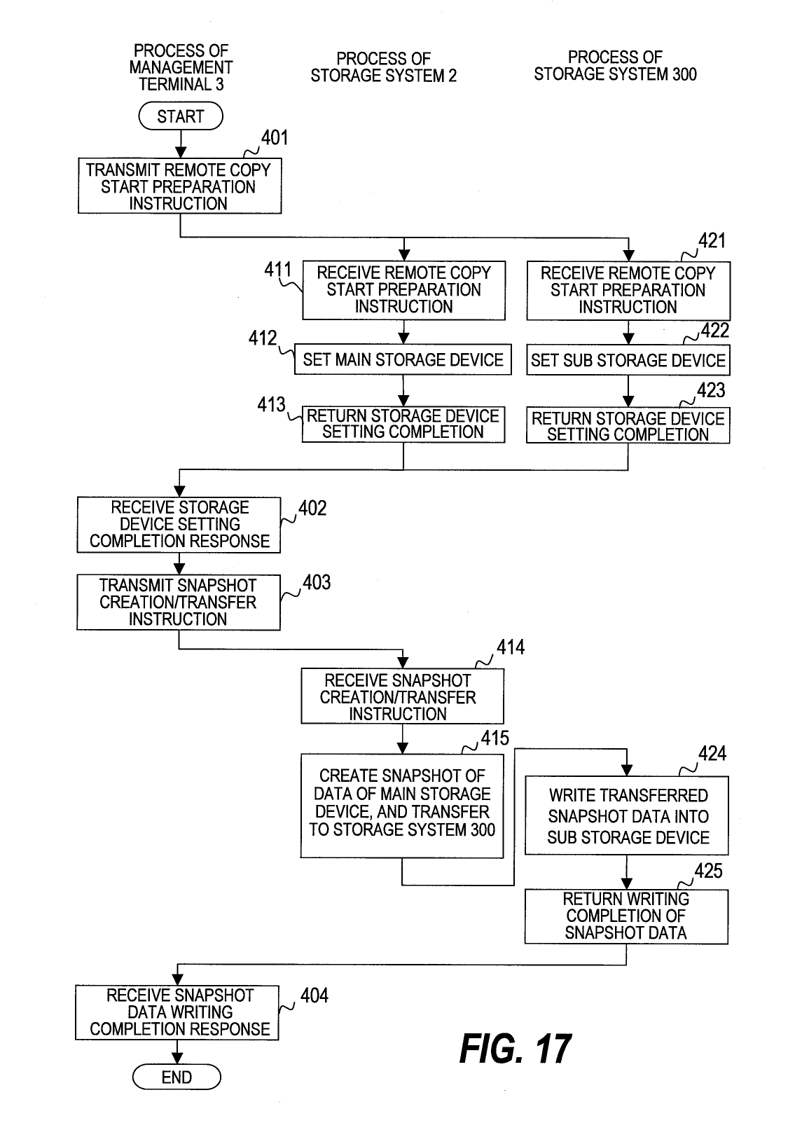

FIG. 17 is a flowchart showing a procedure of a remote copy start preparation process in accordance with the second embodiment of this invention.

First, the management terminal 3 transmits a report copy start preparation instruction to the storage system 2 which includes the main storage device 310 and the storage system 300 which includes the sub storage device 331 (step 401).

Upon reception of the remote copy start preparation instruction (step 411), the controller 20 of the storage system 2 sets a main storage device 310 (step 412). Upon completion of the setting of the main storage device 310, the controller 20 notifies the completion of the setting of the main storage device 310 to the management terminal 3 (step 413). Similarly, upon reception of the remote copy start preparation instruction (step 421), the controller 320 of the storage system 300 sets a sub storage device 331 (step 422). Upon completion of the setting of the sub storage device 331, the controller 320 transmits a response indicating the setting completion of the sub storage device 331 to the management terminal 3 (step 423).

In this case, whether a RAID configuration of the sub storage device 331 is similar to that of the main storage device 310 should be checked. The process below is continued irrespective of whether there are any similarities or differences. If whether the RAID configuration of the main and sub storage devices 310 and 331 are similar is stored in the controller, this information can be used during remote copy execution.

Upon reception of the setting completions of the main and sub storage devices from the storage systems 2 and 300 (step 402), the management terminal 3 transmits snapshot creation/transfer instruction to the storage system 2 which includes the main storage system 310 (step 403).

Upon reception of the snapshot creation/transfer instruction transmitted from the management terminal 3 (step 414), the controller 20 of the storage system 2 creates a snapshot of data stored in the main storage device 310 according to the instruction to transfer it to the storage system 300 (step 415).

The controller 320 of the storage system 300 writes the snapshot data transferred from the storage system 2 in the sub storage device 331 (step 424). Upon completion of the writing of the snapshot data, the controller 320 transmits a completion response to the management terminal 3.

The management terminal 3 receives the writing completion response of the snapshot data from the storage system 300 (step 404) to finish the process.

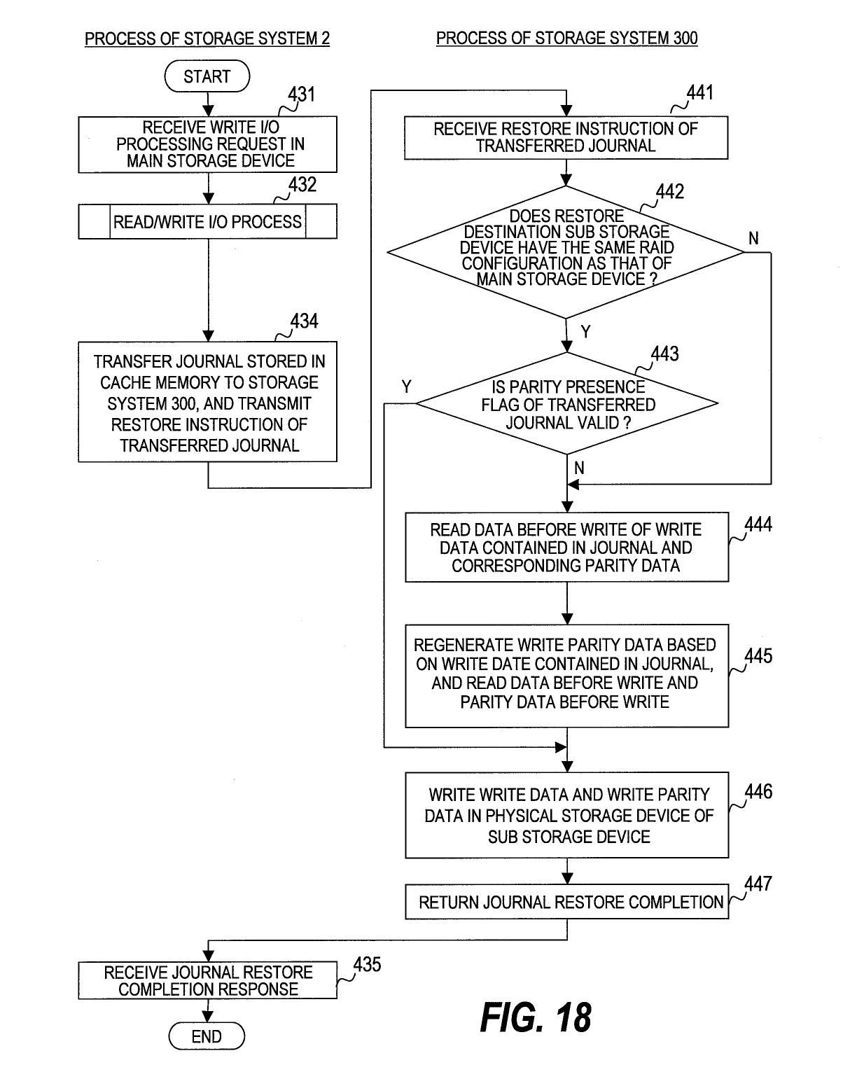

FIG. 18 is a flowchart showing a procedure of the remote copy process in accordance with the second embodiment of this invention.

Upon reception of a write I/O processing request in the main storage device 310 (step 431), the controller 20 of the storage system 2 executes a processing according to the received I/O processing request (step 432). The processing of the step 432 is similar to that described above referring to FIG. 11.

Specifically, the controller 20 stores write data in the cache memory 26 upon reception of the write I/O processing request in the main storage device 310. The controller 20 executes a journal creation process.

In the journal creation process, the controller 20 reads data before write and parity data before write to regenerate write parity data. The controller 20 writes the write data and the write parity data in the cache memory 26 or the physical storage device 28, and creates a journal to store the journal in the cache memory 26 according to setting as to whether to contain parity data in a journal.

In the case of setting to contain parity data in a journal, the controller 20 judges that a parity presence flag is valid to create a journal containing the write data and the write parity data. In the case of setting not to contain parity data in a journal, the controller 20 judges that the parity presence flag is invalid to create a journal containing the write data.

The controller 20 may notify completion of the write I/O process to the host computer 1 without waiting for an end of the journal creation process.

Through the journal creation process, the controller 20 transfers the journal stored in the cache memory to the storage system 300, and transmits a restore instruction of the journal to be transferred (step 434). The controller 20 may asynchronously execute a transfer process of the journal from the storage system 2 to the storage system 300.

Upon reception of the restore instruction of the transferred journal (step 441), the controller 320 of the storage system 300 judges whether a sub storage device 331 of a restore destination has the same RAID configuration as that of the main storage device 310 (step 442).

If the sub and main storage devices 331 and 310 are similar in RAID configuration (result of the step 442 is “Y”), the controller 320 judges whether a value of a parity presence flag contained in the transferred journal is valid (step 443). If the value of the parity presence flag contained in the transferred journal is valid (result of the step 443 is “Y”), the process proceeds to step 446 described below.

If the sub and main storage devices 331 and 310 are different from each other in RAID configuration (result of the step 442 is “N”), or if a value of the parity presence flag contained in the transferred journal is invalid (result of the step 443 is “N”), the controller 320 regenerates parity data.

Specifically, first, the controller 320 reads data before write of write data contained in the journal and corresponding parity data before write (step 444). Next, the controller 320 regenerates write parity data based on the write data contained in the journal and the read data before write and parity data before write (step 445).

The controller 320 writes the parity data contained in the journal or the regenerated parity data together with the write data in the cache memory or the physical storage device 321 of the sub storage device 331 (step 446). The controller 320 transmits a restore completion response of the journal to the storage system 2 (step 447). The controller 320 may asynchronously execute the restore process of the transferred journal from the step 442 to the step 446.

Upon reception of the restore completion response of the journal from the storage system 300 (step 435), the controller 20 of the storage system 2 finishes the process.

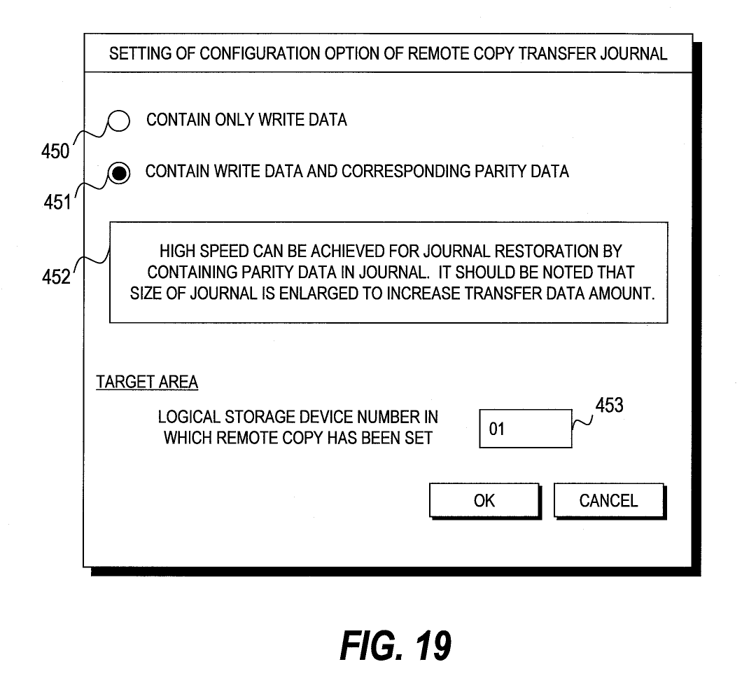

FIG. 19 shows an example of a setting screen of a remote copy journal configuration option according to the second embodiment of this invention.

The setting screen of the remote copy journal configuration option is a user interface for setting whether to contain parity data in a journal. The setting screen of the remote copy journal configuration option is displayed in the management terminal 3 or the host computer 1 by the controller 20.

The administrator can set whether to contain parity data in a journal for a storage device which obtains a remote copy. Specifically, setting is reflected in the storage system 2 by selecting a check box 451, inputting an identification number of the storage device which obtains a remote copy to a character input area 453, and operating an “OK” button.

On the other hand, by selecting a check box 450, the administrator can set noninclusion of parity data in a journal. When inclusion of parity data in a journal is set, the controller 20 may display a message indicating a function or an effect in a display unit 452. For example, as shown in FIG. 19, a message that a capacity necessary for storing the journal increases while a high speed is achieved for restoration can be displayed.

According to the second embodiment of this invention, by creating and transferring a journal which contains write data and write parity data, the data stored in the main storage device 310 can be restored to the sub storage device 331 at a high speed without any write penalties. Especially, the embodiment is effective for AP which has many small random write I/O processing requests as in the case of DBMS.

Furthermore, according to the second embodiment of this invention, as write parity data is generated by being contained in a journal by extension of the write I/O process, the invention can be implemented with a small load on the storage system 2.

While the present invention has been described in detail and pictorially in the accompanying drawings, the present invention is not limited to such detail but covers various obvious modifications and equivalent arrangements, which fall within the purview of the appended claims.

What is claimed is:

1. A storage system coupled to a host computer, comprising:
a control unit for processing an access request transmitted from the host computer;
a first storage device for storing data accessed by the host computer; and
a second storage device for storing update content of the data stored in the first storage device as a journal, wherein:
the first storage device has a RAID configuration for recording parity data dispersedly in a plurality of physical storage devices; and
the control unit is configured to:
create updated parity data based on updated data in case of reception of an instruction of updating the data stored in the first storage device, store the updated data and the updated parity data in the first storage device, create at least one journal including the updated data and the updated parity data, and record the created journal in the second storage device;
read sequentially at least one of the journals recorded in the second storage device before a restore point in the recorded order in case of reception of a data restore instruction including the restore point for the data stored in the first storage device, and write the updated data and the updated parity data included in the read journal in the first storage device.

2. The storage system according to claim 1, wherein the control unit is further configured to:
copy the data stored in the first storage device to a storage device other than the first storage device in case of reception of a predetermined instruction; and
restore, upon reception of the data restore instruction including the restore point, the data stored in the first storage device by copying in the first storage device the data latest copied in response to the predetermined instruction before the restore point and using at least one of the journal recorded in the second storage device from a time point of copying the restored data to the restore point.

3. The storage system according to claim 1, wherein:
the control unit comprises an interface for receiving a setting as to whether the journals recorded in the second storage device includes the updated parity data in case of reception of the update instruction; and
the control unit is further configured to set whether to include the updated parity data in the journal based on the received setting.

4. The storage system according to claim 1, wherein the control unit is further configured to notify a storage capacity used by the updated parity data stored in the second storage device.

5. The storage system according to claim 1, wherein:
the journal can include information indicating whether the journal includes the updated parity data; and
the control unit is further configured to set the information indicating whether the journal includes the updated parity data, and create the journal based on the set information.

6. The storage system according to claim 5, wherein the control unit is further configured to:
judge whether the journal read from the second storage device includes the updated parity data based on the set information indicating whether the journal includes the updated parity data in case of reception of the data restore instruction;
write the updated data and the updated parity data included in the journal into the first storage device when it is judged that the read journal includes the updated parity data;
read data before update of the updated data included in the journal and parity data before update corresponding to the data before update from the first storage device when it is judged that the updated parity data is not included in the read journal; and
create updated parity data based on the parity data before update, the data before update, and the updated data, and write the updated data and the created updated parity data in the first storage device.

7. The storage system according to claim 1, further comprising a third storage device, wherein the control unit is further configured to:
copy the data stored in the first storage device to another storage device upon reception of a predetermined instruction;
judge whether a RAID configuration of the third storage device is same as that of the first storage device in case of reception of an instruction of restoring in the third storage device the data stored in the first storage device at the restore point;
restore latest copied data before the restore point in the third storage device when it is judged that the RAID configuration of the third storage device is same as that of the first storage device; and
write the updated data and the updated parity data included in the journal read from the second storage device in the third storage device.

8. A remote copy system, comprising:
a first storage system coupled to a host computer; and
a second storage system coupled to the first storage system, the second storage system storing data copied from the first storage system, wherein:
the first storage system includes a first storage device for storing data accessed by the host computer;
the first storage device has a RAID configuration recording parity data with dispersing in a plurality of physical storage devices;
the second storage system comprises a second storage device for storing a copy of the data stored in the first storage device;
the second storage device has a RAID configuration same as the RAID configuration of the first storage device;
the first storage system is configured to:
create updated parity data based on updated data in case of reception of an instruction of updating the data stored in the first storage device;
create a journal including the created updated parity data and the updated data; and
transfer the created journal to the second storage system; and
the second storage system is configured to store the updated data and the updated parity data included in the transferred journal in the second storage device in an order with which the journal has been created.

9. The remote copy system according to claim 8, wherein:
the first storage system comprises an interface for receiving a setting as to whether the journal includes the updated parity data in case of reception of the update instruction; and
the first storage system makes a setting as to whether to include the updated parity data in the journal based on the received setting.

10. The remote copy system according to claim 8, wherein:
the journal includes information indicating whether the journal includes the updated parity data; and
the first storage system is further configured to set the information indicating whether the journal includes the updated parity data, and create the journal based on the set information.

11. The remote copy system according to claim 10, wherein the second storage system is further configured to:
judge whether the setting is made to include the updated parity data in the transferred journal based on the set information indicating whether the updated parity data is contained in the journal;
store the updated data and the updated parity data included in the transferred journal into the second storage device when it is judged that the setting is made to include the updated parity data in the transferred journal;
read data before update of the updated data included in the transferred journal and parity data before update corresponding to the data before update from the second storage device when it is judged that the setting is made not to contain the updated parity data in the transferred journal; and
create updated parity data based on the parity data before update, the data before update, and the updated data, and store the updated data and the created updated parity data in the second storage device.

12. A data restoration method, which is executed in a storage system which is coupled to a host computer and includes a first storage device for storing data accessed by the host computer and a second storage device for storing update content of the data stored in the first storage device as a journal, the first storage device having a RAID configuration for recording parity data which is redundant data dispersedly in a plurality of physical storage devices,
the storage system being configured to: create updated parity data based on updated data in case of reception of an instruction of updating the data stored in the first storage device, store the updated data and the updated parity data in the first storage device, create a journal including the updated data and the updated parity data, and record the created journal in the second storage device, the method comprising:
reading sequentially the journal recorded in the second storage device before a restore point in the recorded order in case of reception of a data restore instruction including the restore point for the data stored in the first storage device; and
writing the updated data and the updated parity data included in the read journal in the first storage device.

13. The data restoration method according to claim 12, further comprising:
copying the data stored in the first storage device to a storage device other than the first storage device upon reception of a predetermined instruction;
restoring the data latest copied in response to the predetermined instruction before the restore point in the first storage device, upon reception of the data restore instruction including the restore point; and
restoring the data stored in the first storage device by using journal recorded in the second storage device from a time point of copying the restored data to the restore point.

14. The data restoration method according to claim 12, wherein:
the storage system includes an interface for receiving a setting as to whether the journals recorded in the second storage device includes the updated parity data in case of reception of the update instruction; and
the method further comprises making a setting as to whether to include the updated parity data in the journal based on the received setting.

15. The data restoration method according to claim 12, further comprising notifying a storage capacity used by the updated parity data stored in the second storage device.

16. The data restoration method according to claim 12, wherein:
the journal can include information indicating whether the journal includes the updated parity data; and
the method further comprises making a setting the information indicating whether the journal includes the updated parity data, and creating the journal based on the set information.

17. The restoration method according to claim 16, further comprising:
judging whether the journal read from the second storage device includes in the updated parity data based on the set information indicating whether the journal includes the updated parity data in case of reception of the data restore instruction;
writing the updated data and the updated parity data included in the journal into the first storage device when it is judged that the read journal includes the updated parity data;
reading data before update of the updated data included in the journal and parity data before update corresponding to the data before update from the first storage device when it is judged that the updated parity data is not included in the read journal; and
creating updated parity data based on the parity data before update, the data before update, and the updated data, and writing the updated data and the created updated parity data in the first storage device.

18. The data restoration method according to claim 12, wherein:
the storage system further includes a third storage device; and
the method further comprises:
copying the data stored in the first storage device to another storage device upon reception of a predetermined instruction;
judging whether a RAID configuration of the third storage device is same as that of the first storage device in case of reception of an instruction of restoring the data stored in the first storage device at the restore point in the third storage device;
restoring latest copied data before the restore point in the third storage device when it is judged that the RAID configuration of the third storage device is same as that of the first storage device; and
writing the updated data and the updated parity data included in the journal read from the second storage device in the third storage device.
